(19) United States
(12) Patent Application Publication
(10) Pub. No.: US 2013/0213885 A1
(43) Pub. Date: Aug. 22, 2013

(54) FORWARD OSMOSIS SYSTEM AND PROCESS

(71) Applicant: KING ABDULLAH UNIVERSITY OF SCIENCE AND TECHNOLOGY, (US)

(72) Inventor: Jintang DUAN, Thuwal (SA)

(73) Assignee: KING ABDULLAH UNIVERSITY OF SCIENCE AND TECHNOLOGY, Thuwal (SA)

(21) Appl. No.: 13/762,685

(22) Filed: Feb. 8, 2013

Related U.S. Application Data
(60) Provisional application No. 61/597,737, filed on Feb. 11, 2012.

(51) Int. Cl. C02F 1/44

(52) U.S. Cl. CPC C02F 1/445
USPC 210/636; 210/644; 210/321.6

(57) ABSTRACT

A forward osmosis fluid purification system includes a cross-flow membrane module with a membrane, a channel on each side of the membrane which allows a feed solution and a draw solution to flow through separately, a feed side, a draw side including a draw solute, where the draw solute includes an aryl sulfonate salt. The system can be used in a process to extract water from impure water, such as wastewater or seawater. The purified water can be applied to arid land.

### CLAIM FOR PRIORITY

This application claims priority to U.S. Patent Application No. 61/597,737, filed Feb. 11, 2012, which is hereby incorporated by reference in its entirety.

### TECHNICAL FIELD

This invention relates to a forward osmosis system and process.

### BACKGROUND OF THE INVENTION

Efficient, economical, and simple water purification systems can be important to create easy access to water for drinking, irrigation, make-up water for cooling, or arid land treatment.

### SUMMARY

A forward osmosis system can be based on an aryl sulfonate salt as a draw solute.

In one aspect, a forward osmosis fluid purification system includes a membrane module including a membrane, a channel on each side of the membrane, which allows a feed solution and a draw solution to flow through separately, a feed side configured to contain a solution containing unpurified water, for example, that contains undesired solutes in it, and a draw side including a draw solute, where the draw solute can include aryl sulfonate salt. In another embodiment, the draw solute can include sodium lignin sulfonate. The module can be a spiral-wound module or a hollow fiber module.

In another aspect, a process for extracting water from wastewater or seawater includes the steps of passing water from a feed solution that contains water and at least one solute dissolved in it with a first osmotic pressure, through a membrane into a second solution that contains a draw solute including an aryl sulfonate salt with a second osmotic pressure, where the first osmotic pressure is smaller than the second osmotic pressure. In a further aspect, the draw solute can include sodium lignin sulfonate. In some embodiments, the concentration of the solution with the draw solute can have between 40 and 100 grams of draw solute per 100 grams of water, for example about 60 grams to 70 grams of draw solute per 100 grams of water. In another aspect, the membrane can be cleaned periodically so that the flux remains high.

Other aspects, embodiments, and features will be apparent from the following description, the drawings, and the claims.

### DETAILED DESCRIPTION OF THE DRAWINGS

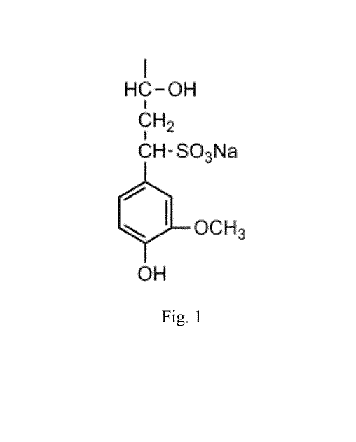

FIG. 1 is the structure of the compound sodium lignin sulfonate.

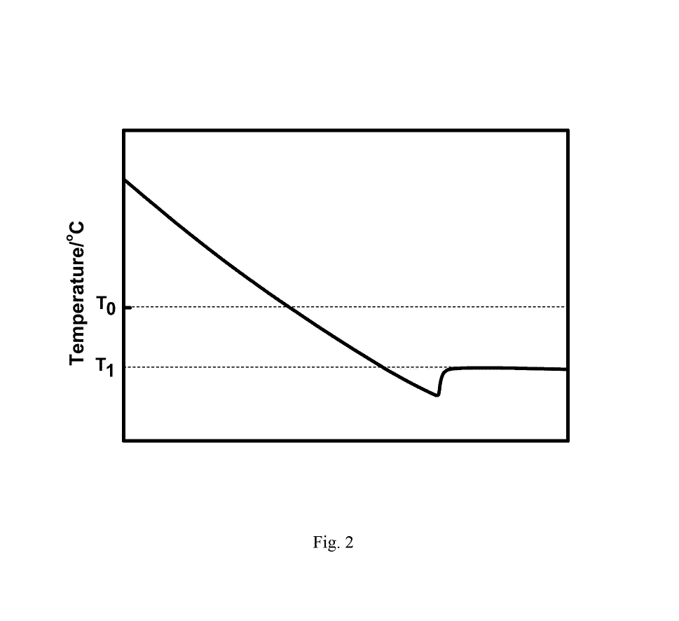

FIG. 2 is a depiction of a freezing curve with time of 1 mol NaCl in 1 L H₂O.

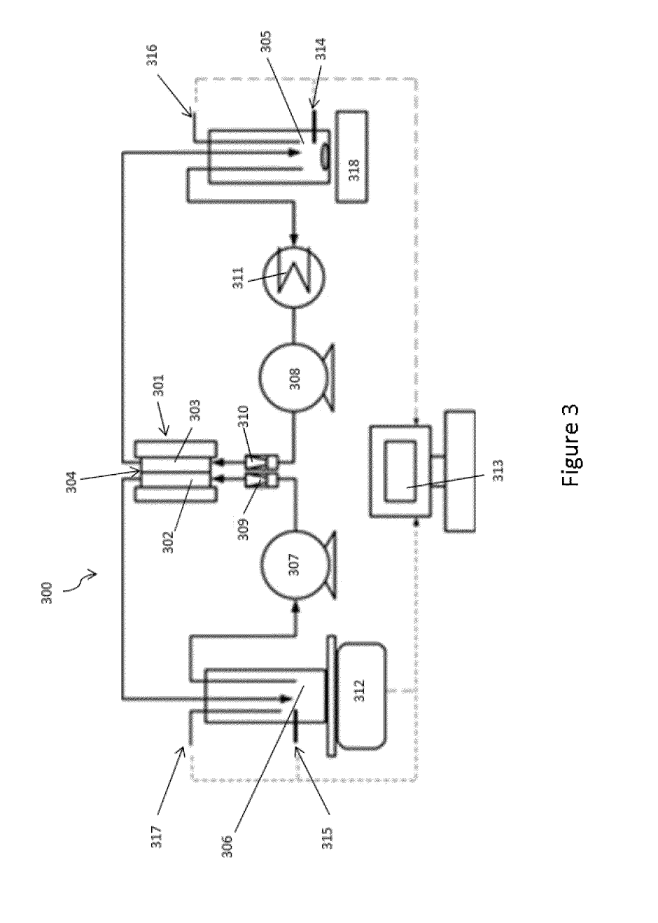

FIG. 3 is a schematic diagram of a laboratory-scale forward osmosis setup.

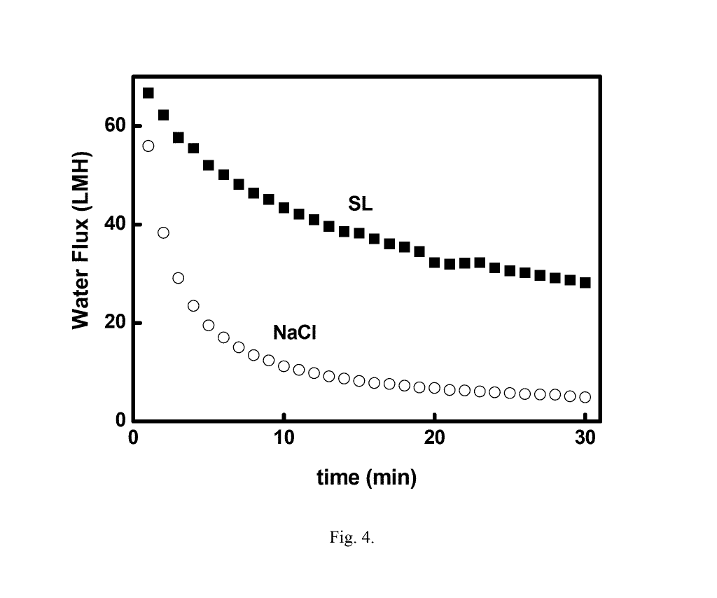

FIG. 4 is a graph representation of RO₁ membrane performance in a forward osmosis (FO) test with NaCl and sodium lignin sulfonate (SL).

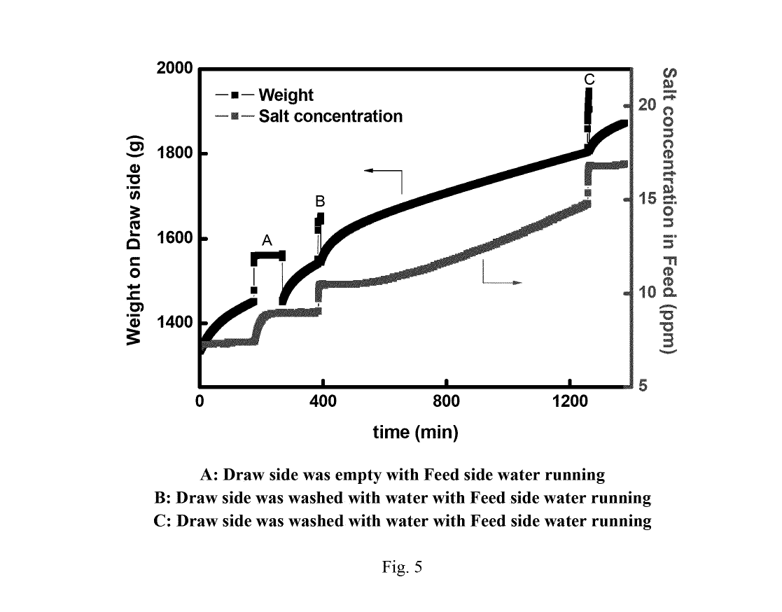

FIG. 5 is original data of weight change on the draw side and salt concentration in feed of an RO₁ membrane with sodium lignin sulfonate as the draw solute (DS) during the cleaning process.

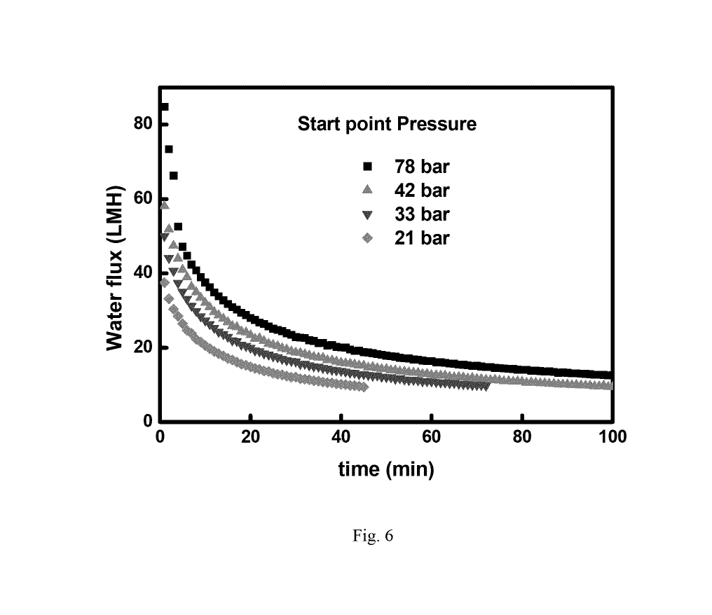

FIG. 6 is a graph of an NF270 membrane forward osmosis performance using sodium lignin sulfonate as draw solute under different osmotic pressures. At each interval, the draw side was washed with water for 20 seconds with feed side water running.

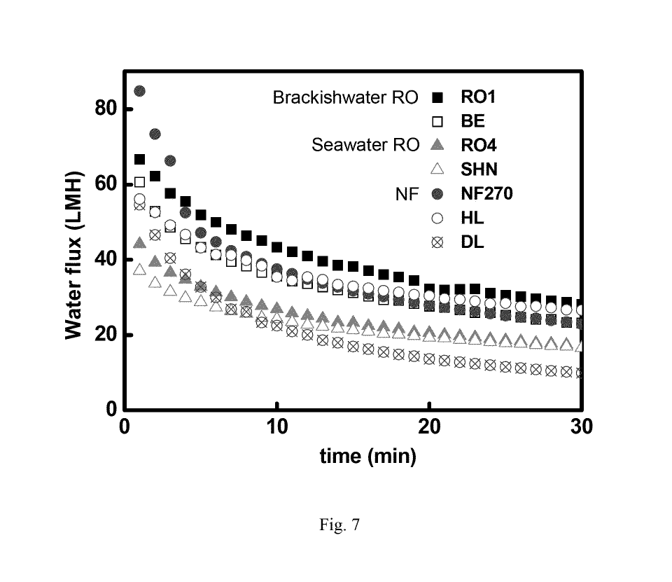

FIG. 7 is a graph of water flux with time for PA-based THF membranes in a forward osmosis test using sodium lignin sulfonate as the draw solute.

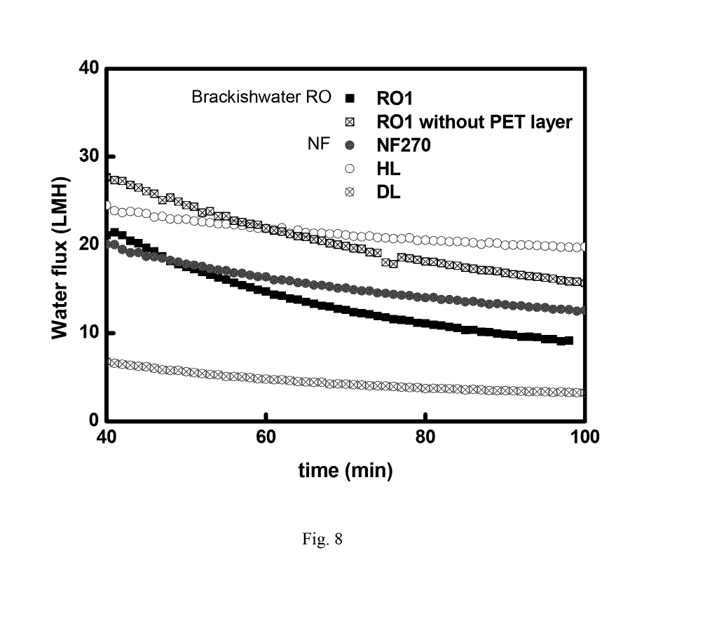

FIG. 8 is a steady stage forward osmosis performance of RO₁, RO₁ without PET fabric layer, NF270, HL, and DL membranes using sodium lignin sulfonate as the draw solute.

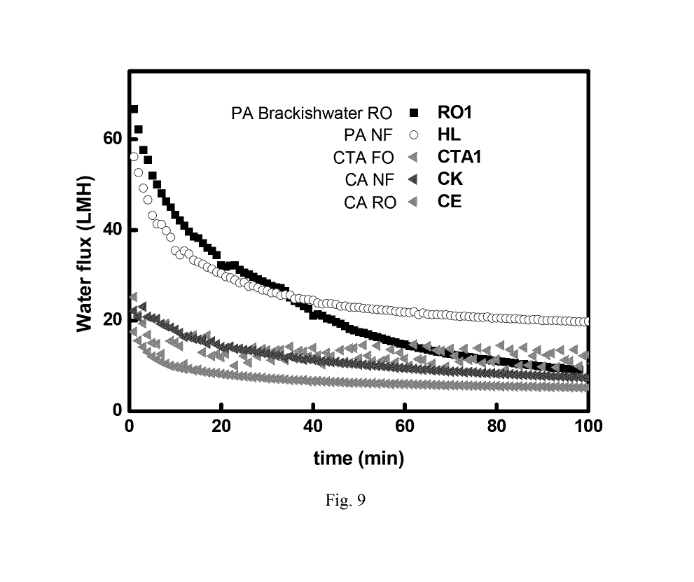

FIG. 9 is a forward osmosis performance comparison between CA/CT-based membranes and PA-based membranes using sodium lignin sulfonate as the draw solute.

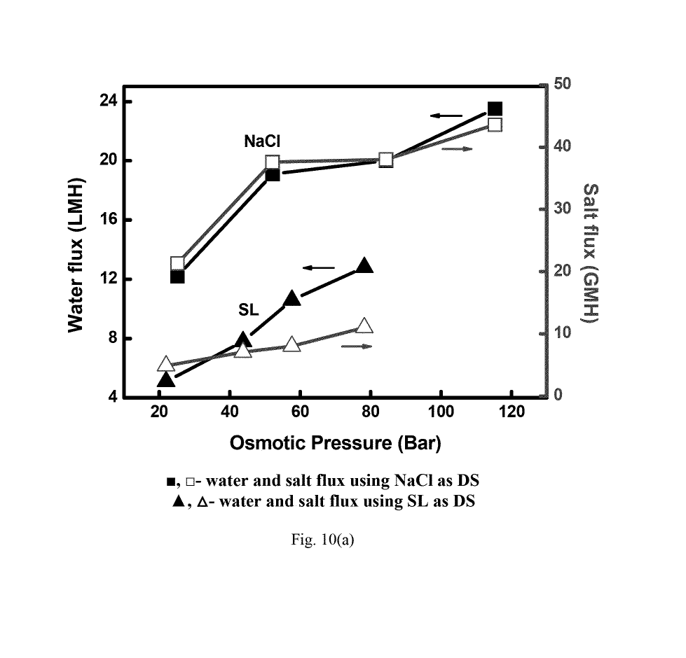

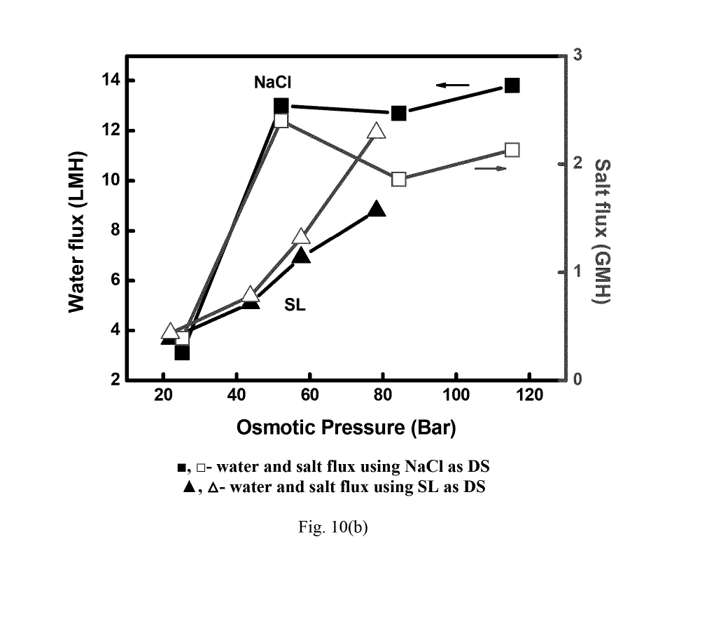

FIGS. 10(a) and 10(b) are a comparison of HTI membrane forward osmosis performance of NaCl and sodium lignin sulfonate under different osmotic pressures. FIG. 10(a) displays the results of test conditions using the CTA1 membrane. FIG. 10(b) displays the results of conditions using the CTA2 membrane.

### DETAILED DESCRIPTION OF THE INVENTION

Energy and freshwater shortages are two big issues the world is facing today, which are expected to grow worse in the future. (See M. Elimelech, W. A. Phillip, The Future of Seawater Desalination: Energy, Technology, and the Environment, Science, 333 (2011) 712-717; World Energy Outlook 2010, The Energy Information Administration, E. International (Ed.), 2010, each of which is incorporated by reference in its entirety). The conventional technology to acquire water in water reuse and seawater desalination, e.g. reverse osmosis (RO), requires intense energy input. (See M. Elimelech, et al.; G. M. Geise, et al., Water Purification by Membranes: The Role of Polymer Science, Journal of Polymer Science Part B-Polymer Physics, 48 (2010) 1685-1718, each of which is incorporated by reference in its entirety). How to reduce the energy requirement has become the focus of many researchers and engineers. Among the many technologies, forward osmosis (FO) seems promising and has developed quickly in the last five years. (See T. Y. Cath, et al., Forward osmosis: Principles, applications, and recent developments, Journal of Membrane Science, 281 (2006) 70-87; J. R. McCutcheon, et al., Forward (direct) osmosis desalination using polymeric membranes, Abstracts of Papers of the American Chemical Society, 228 (2004) U633-U633; R. Semiat, et al., Energy aspects in osmotic processes, Desalination and Water Treatment, 15 (2010) 228-235; N. Y. Yip, et al., High Performance Thin-Film Composite Forward Osmosis Membrane, Environmental Science & Technology, 44 (2010) 3812-3818; L. Setiawan, et al., Fabrication of novel poly(amide-imide) forward osmosis hollow fiber membranes with a positively charged nanofiltration-like selective layer, Journal of Membrane Science, 369 (2011) 196-205, each of which is incorporated by reference in its entirety). Forward osmosis utilizes osmotic pressure as the driving force to draw the solvent from the less concentrated solution to the higher concentrated one through a semi-permeable membrane. It allows high feedwater recovery and requires very little energy input. (See C. R. Martinetti, et al., High recovery of concentrated RO brines using forward osmosis and membrane distillation, Journal of Membrane Science, 331 (2009) 31-39; R. L. McGinnis, et al., Energy requirements of ammonia-carbon dioxide forward osmosis desalination, Desalination, 207 (2007) 370-382, each of which is incorporated by reference in its entirety).

However, two main obstacles exist in forward osmosis: a novel membrane and a proper draw solute (DS). Unlike reverse osmosis, forward osmosis membranes do not need to withstand high hydraulic pressure, and conventional reverse osmosis membranes give very low water flux due to the severe internal concentration polarization (ICP) within the support. (See J. T. Arena, et al., Surface modification of thin film composite membrane support layers with polydopamine: Enabling use of reverse osmosis membranes in pressure retarded osmosis, Journal of Membrane Science, 375 (2011) 55-62, which is incorporated by reference in its entirety). To get high water flux and minimum salt passage, many efforts have been made in membrane design. (See N. Y. Yip, et al; L. Setiawan et al; K. Y. Wang, et al., Polybenzimidazole (PBI) nanofiltration hollow fiber membranes applied in forward osmosis process, Journal of Membrane Science, 300 (2007) 6-12; Q. Yang, et al., Dual-Layer Hollow Fibers with Enhanced Flux As Novel Forward Osmosis Membranes for Water Production, Environmental Science & Technology, 43 (2009) 2800-2805; R. Wang, et al., Characterization of novel forward osmosis hollow fiber membranes, Journal of Membrane Science, 355 (2010) 158-167; J. C. Su, et al., Cellulose acetate nanofiltration hollow fiber membranes for forward osmosis processes, Journal of Membrane Science, 355 (2010) 36-44; S. Zhang, et al., Well-constructed cellulose acetate membranes for forward osmosis: Minimized internal concentration polarization with an ultra-thin selective layer, Journal of Membrane Science, 360 (2010) 522-535; J. R. McCutcheon, M. Elimelech, Influence of membrane support layer hydrophobicity on water flux in osmotically driven membrane processes, Journal of Membrane Science, 318 (2008) 458-466; K. Y. Wang, et al., Double-Skinned Forward Osmosis Membranes for Reducing Internal Concentration Polarization within the Porous Sublayer, Industrial & Engineering Chemistry Research, 49 (2010) 4824-4831; A. Tiraferri, et al., Relating performance of thin-film composite forward osmosis membranes to support layer formation and structure, Journal of Membrane Science, 367 (2011) 340-352; J. Wei, et al., Synthesis and characterization of flat-sheet thin film composite forward osmosis membranes, Journal of Membrane Science, 372 (2011) 292-302; X. X. Song, et al., Nano Gives the Answer: Breaking the Bottleneck of Internal Concentration Polarization with a Nanofiber Composite Forward Osmosis Membrane for a High Water Production Rate, Adv Mater, 23 (2011) 3256; L. Shi, et al., Effect of substrate structure on the performance of thin-film composite forward osmosis hollow fiber membranes, Journal of Membrane Science, 382 (2011) 116-123; each of which is incorporated by reference in its entirety).

The draw solute (DS) is the solute on the higher concentrated side of the membrane. It affects the water flux and salt passage; meanwhile, it determines the economic feasibility, process complexity and applications. Generally, draw solute can be divided into two groups: (1) draw solute that needs to be separated afterwards and (2) draw solute that does not. The primary application of the draw solute that needs to be separated is to produce drinkable freshwater, like the ammonia bicarbonate proposed by M. Elimelech (removed by heat treatment) and the magnetic particles proposed by N. Chung (removed by magnetic field). (See J. R. McCutcheon, et al., A novel ammonia-carbon dioxide forward (direct) osmosis desalination process, Desalination, 174 (2005) 1-11; J. R. McCutcheon, et al., Desalination by ammonia-carbon dioxide forward osmosis: Influence of draw and feed solution concentrations on process performance, Journal of Membrane Science, 278 (2006) 114-123; M. M. Ling, et al., Highly Water-Soluble Magnetic Nanoparticles as Novel Draw Solutes in Forward Osmosis for Water Reuse, Industrial & Engineering Chemistry Research, 49 (2010) 5869-5876; each which is incorporated by reference in its entirety). Applications of draw solute that do not need to be removed vary: Hydration Technologies Inc. (HTI) uses syrup in their life bag products; K. Petrotos proposed sodium chloride brine to concentrate the tomato juice; and H. Shon proposed fertilizer in the irrigation. (See K. B. Petrotos, et al., Direct osmotic concentration of tomato juice in tubular membrane-module configuration. II. The effect of using clarified tomato juice on the process performance, Journal of Membrane Science, 160 (1999) 171-177; S. Phuntsho, et al., A novel low energy fertilizer driven forward osmosis desalination for direct fertigation: Evaluating the performance of fertilizer draw solutions, Journal of Membrane Science, 375 (2011) 172-181, each of which is incorporated by reference in its entirety).

A forward osmosis fluid purification system and a process for extracting water from impure water, such as wastewater or seawater using such a system can be developed based on an aryl sulfonate salt draw solute. Forward osmosis is the process of water being drawn from a feed side containing a solution with a solute through a membrane to a draw side containing a draw solute, wherein the driving force is created by an osmotic pressure gradient, where a lesser osmotic pressure on the draw side of the membrane causes the water on the feed side of the membrane with a lower osmotic pressure to be pulled through the membrane onto the draw side. The system can include a membrane module, which can be either a spiral-wound or hollow fiber membrane system.

In one aspect, the forward osmosis system provides a system including a membrane module with a semi-permeable membrane, a channel on each side of the membrane, one on the feed side and one of the draw side, and a feed side including a solution of water with solutes in it, and a draw side including a draw solute. In another aspect, the draw solute can include an aryl sulfonate salt. In yet another aspect, the draw solute can include sodium lignin sulfonate. In certain embodiments, the draw solute can include a combination of salts, for example, an aryl sulfonate salt combined with one or more of sodium tripolyphosphate, or calcium stearate.

Selection of a draw solute that produces high water throughput, that is easy to remove from the purified water (or that does not have to be removed for some uses), and are readily accessed make certain aryl sulfonate salts excellent candidates for a draw solute. The aryl sulfonate salt can be a lignin salt. The aryl sulfonate salt can be an alkali or alkaline earth salt of a compound of formula (I):

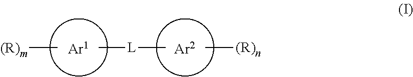

in which each of Ar¹ and Ar², independently, is an aryl group, such as phenyl, pyridyl, or naphthyl, each n and m, independently, is 0, 1, 2 or 3, L is a substituted or unsubstituted C₁-C₆ alkylene or alkenylene group optionally interrupted by O, S or NR^{a}, wherein the substituent is OH, OR^{a}, SH, Sle, NH₂, NHR^{a}, NR^{a}₂, COOH, COOR², or SO₃OH, each R, independently, is OH, OR^{a}, SH, SR^{a}, NH₂, NHR^{a}, NR^{a}₂, COOH, COOR², or SO₃OH, and each R^{a} is substituted or unsubstituted C₁-C₆ alkyl or alkenyl group optionally interrupted by O, S or NR^{a}, wherein the substituent is OH, OR^{a}, SH, SR^{a}, NH₂, NHR^{a}, NR^{a}₂, COOH, COOR², or SO₃OH, in which at least two substituents are sulfonic acid or carboxylic acid.

In certain embodiments, the draw solute can be an alkali or alkaline earth salt of a compound of formula (II)

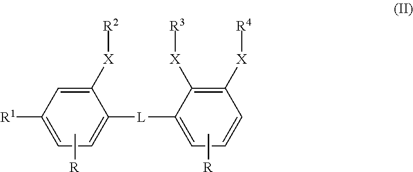

in which, L is a substituted or unsubstituted C₁-C₆ alkylene or alkenylene group optionally interrupted by O, S, NH or NR^{a}, wherein the substituent is OH, OR^{a}, SH, SR^{a}, NH₂, NHR^{a}, NR^{a}₂, COOH, COOR², or SO₃OH, each R, independently, is OH, OR^{a}, SH, SR^{a}, NH₂, NHR^{a}, NR^{a}₂, COOH, COOR², or SO₃OH, each X, independently, is O, S, NH or NR^{a}, each of R¹, R², R³ and R⁴ is substituted or unsubstituted C₁-C₆ alkyl or alkenyl group optionally interrupted by O, S or NR^{a}, wherein the substituent is OH, OR^{a}, SH, SR^{a}, NH₂, NHR^{a}, NR^{a}₂, COOH, COOR², or SO₃OH, and each R^{a} is substituted or unsubstituted C₁-C₆ alkyl or alkenyl group optionally interrupted by O, S or NR^{a}, wherein the substituent is OH, OR^{a}, SH, SR^{a}, NH₂, NHR^{a}, NR^{a}₂, COOH, COOR², or SO₃OH, in which at least two substituents are sulfonic acid or carboxylic acid.

In certain embodiments, the draw solute can be an alkali or alkaline earth salt of a compound of formula (III)

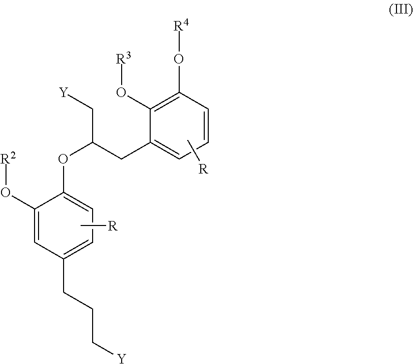

in which, each Y, independently, is OH, OR^{a}, SH, SR^{a}, NH₂, NHR^{a}, NR^{a}₂, COOH, COOR², or SO₃OH, each R, independently, is OH, OR^{a}, SH, SR^{a}, NH₂, NHR^{a}, NR^{a}₂, COOH, COOR², or SO₃OH, each of R², R³ and R⁴ is substituted or unsubstituted C₁-C₆ alkyl or alkenyl group optionally interrupted by O, S or NR^{a}, wherein the substituent is OH, OR^{a}, SH, SR^{a}, NH₂, NHR^{a}, NR^{a}₂, COOH, COOR², or SO₃OH, and each R^{a} is substituted or unsubstituted C₁-C₆ alkyl or alkenyl group optionally interrupted by O, S or NR^{a}, wherein the substituent is OH, OR^{a}, SH, SR^{a}, NH₂, NHR^{a}, NR^{a}₂, COOH, COOR², or SO₃OH, in which at least two substituents are sulfonic acid or carboxylic acid.

In certain embodiments, the salt is a lithium, sodium, potassium, or calcium salt.

In general, the membrane can be a semi-permeable membrane. The membrane can be configured to permit diffusion of the fluid from the feed solution into the draw solution. Examples of suitable forward osmosis membranes include membranes formed from cellulose acetate, polyamide, or cellulose triacetate (CTA) on a heat-welded polyethylene/polyester backing or CTA cast with an embedded polyester screen. Examples of acceptable membranes are available from by Hydration Technologies Inc.

A suitable concentration for the draw solute can be higher than 15%, 20%, 30%, or 40 of the water on a weight basis. In certain embodiments, the concentration of the draw solute can be between 30 and 40 weight percent. In typical forward osmosis systems, the water flow rate can be greater than 5, greater than 10, greater than 20, or greater than 25 liters per square meter of membrane area per hour (LMH). In certain embodiments, the water flow rate can be between 20 and 30 LMH

The purified water can be used for projects that do not require removal of the aryl sulphonate salt. For example, lignin salts are biproducts of the lumber and paper industries, arising from plant materials. Uses of the purified water, for example, in irrigation or similar purposes without removal of the lignin salt.

In a further aspect, a process for extracting water from wastewater or seawater can include passing water from a feed solution through a membrane into a draw solution. Over time, the membrane needs to be cleaned. The membrane can be cleaned so that the flux of water passing from the feed solution to the draw solution remains high. Typical cleaning methods include mechanical removal of fouling materials, for example, by scraping, scrubbing, sonication or agitation.

Sodium lignin sulfonate (SL) is proposed as a new draw solute in forward osmosis (FO) process to extract water from the wastewater or seawater. Sodium lignin sulfonate is a good sand fixation agent to restore green in desertificated land. The advantages of using sodium lignin sulfonate in forward osmosis includes that it is a naturally abundant material from the waste of paper-making factories at a cheap price, and does not need to be recovered. The potential of using sodium lignin sulfonate in forward osmosis has been investigated in the development of the present invention. First, the osmotic pressure of sodium lignin sulfonate is determined by a freezing point depression test. High osmotic pressure can be achieved due to sodium lignin sulfonate's good solubility. Then several types of commercially available polyamide (PA)-based or cellulose acetate (CA)/cellulose triacetate (CTA)-based reverse osmosis (RO), NF, and forward osmosis membranes were tested. Due to sodium lignin sulfonate's large molecular size, an unsteady state of more than 30 minutes with high water flux is observed for PA-based reverse osmosis, NF membranes with deionized (DI) water as feed. This unsteady period can be taken into use with an easy cleaning method to maintain the high water flux.

In one aspect, sodium lignin sulfonate (SL) can be used as the draw solute. As shown in FIG. 1, sodium lignin sulfonate is a polymer which contains both hydrophilic groups (sulfonic, phenylic hydroxyl, and alcoholic hydroxyl) and hydrophobic groups (carbon chain). (See X. P. Ouyang, et al., Corrosion and scale inhibition properties of sodium lignosulfonate and its potential application in recirculating cooling water system, Industrial & Engineering Chemistry Research, 45 (2006) 5716-5721, incorporated by reference in its entirety). It is known that sodium lignin sulfonate has a good solubility in water, but there is no exact solubility data, which may be due to the different molecular weight and molecular weight distributions of sodium lignin sulfonate. According to experiments related to the present invention carried out with sodium lignin sulfonate purchased from Tokyo Chemical Industry, the solubility exceeds 70 g/100 g H₂O. The solution with 70 g sodium lignin sulfonate in 100 g H₂O has a relatively low viscosity and can flow easily. Additionally, the price for sodium lignin sulfonate is relatively low at around 300 US dollars/ton because it is a byproduct in the pulping waste liquor from acid sulfite pulp mills, and the annual global production of sodium lignin sulfonate is about 50 million tons. (See B. Xiao, et al., The chemical modification of lignins with succinic anhydride in aqueous systems, Polymer Degradation and Stability, 71 (2001) 223-231, incorporated by reference in its entirety).

Existing applications of sodium lignin sulfonate are its use as a dispersing agent and set-retarding agent in concrete; as an additive in oil well drilling, as a cleaning agent; and as an ingredient in animal feeds. It is also known to be a good sand fixation material to restore green on desertificated land. (See L. J. Han-jie Wang, et al., A Preliminary Report on the Field Experiment of Dune Fixation Using lignin-based Sand Stabilization Material, Journal of Nanjing Forestry University (Natural Science Edition), 2 (2008); J. Y. C. LU X. Z., et al., Application of Lignin Sand-Fixer to Vegetation Restoration in Desertificated Areas, Scientia Silvae Sinicae, 41 (2005); D. Z. Wang Laibao, Zhao Shuixia, A preparation method of lignin sulfonate grafting copolymer as chemical sand fixation agent, 2007; each of which is incorporated by reference in its entirety). When a 1% to 2% sodium lignin sulfonate solution is sprayed on the land, water sinks into the sand, leaving the sodium lignin sulfonate on the surface to form a relatively firm ‘sand crust’ with a thickness of about 0.5 cm to about 1 cm. This crust can stabilize the sand, resist the wind and keep the moisture; meanwhile, sodium lignin sulfonate is nontoxic to animals, plants and biodegradable, improves the organic matter content in the soil and provides the nutrients for the plants.

In experiments related, the potential of using sodium lignin sulfonate as the draw solute in forward osmosis process in the desert treating areas was investigated. The osmotic pressure of the sodium lignin sulfonate has been tested with the freezing point depression method. The performance using commercially available reverse osmosis, NF and forward osmosis membranes is reported, and the results are compared with the performance using NaCl as a draw solute.

### EXPERIMENTAL METHODS

### Membranes and Chemicals

Sodium lignin sulfonate, in the form of brown yellow dry powder, was obtained from Tokyo Chemical Industry. Deionized water was used throughout the experiments. Analytical grade sodium chloride was used.

The membranes used are listed in Table 1. Prior to use, CTA1 and CTA2 membranes were soaked in water for 30 minutes, and other membranes were soaked in isopropanol for 30 minutes, followed by a soaking in deionized (DI) water for 10 hours.

TABLE 1
Membranes used in this study

| Classification | Label | Material | Manufacturer |
|---|---|---|---|
| Seawater RO | RO4 | PA TFC | Sepro |
| | SHN | PA TFC | Woongjin |
| | CE | CA on | Osmonics |
| | | polyester fabric | |
| Brackishwater RO | RO1 | PA TFC | Sepro |
| | BE | PA TFC | Woongjin |
| NF | NF270 | PA TFC | Filmtec |
| | DL | PA TFC | Osmonics |
| | HL | PA TFC | Osmonics |
| | CK | CA on | Osmonics |
| | | polyester fabric | |
| FO | CTA1 | CTA on | HTI |
| | | polyester mesh | |
| | CTA2 | CTA on | HTI |
| | | nonwoven fabric | |

### Determination of Osmotic Pressure

The osmotic pressure of the sodium lignin sulfonate solution is difficult to estimate because of the polymer's molecular weight distributions, unknown sulfonate content and unknown impurity types. To accommodate for these unknowns, the freezing point depression method was employed. When a solution is super-cooled, the freezing point temperature T₁ can be obtained from the freezing curve, as shown in FIG. 2. FIG. 2 is an illustration of the freezing curve with temperature changes over a period of time for 1 mol NaCl in 1 L H₂O. With the solvent's freezing point temperature Tₒ, the freezing point temperature depression can be obtained. One mole of any ion dissolved in one kilogram of water will cause an osmotic pressure of 17,000 mmHg and a freezing point depression of −1.86° C. This is expressed by the equation:

Π=(T₀−T₁)/1.86×17,000 mmHg (1)

### Forward Osmosis Performance Test

A schematic diagram of the laboratory scale unit (300) for forward osmosis used in this study is shown in FIG. 3. The specially designed cross-flow membrane cell (301) has a channel (302, 303) on each side of the membrane (304), which allows the feed solution (305) and draw solution (306) to flow through separately. Each channel has dimensions of 2.8 mm, 50 mm, and 100 mm for channel height, length, and width, respectively. Co-current flow was used with a flow rate in each channel that was controlled by a peristaltic pump (307, 308) and a flow meter (309, 310). The cross-flow rates for the feed and draw solution were both maintained at 1.2 L/minute and 0.4 L/minute, respectively. A heat exchanger (311) was used to maintain the feed solution (305) and draw solution (306) at 23° C. A stirrer (318) on the feed side was also used. A weighing scale (312) connected to a computer (313) was used to monitor the weight of water permeating through the membrane from the feed to the draw side, from which the water flux was calculated. A conductivity meter (314) in the feed side was used to determine the salt concentration and thus the salt flux. A draw side conductivity meter (315) also exists to take measurements on the draw side. The laboratory scale unit (300) also comprises a feed-side thermistor (316) and a draw-side thermistor (317).

### Results and Discussion

### Osmotic Pressure of the Sodium Lignin Sulfonate Solution

Various gram measurements of sodium lignin sulfonate were dissolved in 100 grams water. The freezing point temperature depression and the calculated osmotic pressure are listed in Table 2. High osmotic pressure (78 Bar) can be achieved by dissolving 60 grams sodium lignin sulfonate in 100 g H₂O. From the correlation between the freezing point temperature depression and gram measurement m (Equation 2), the linearity is good.

TABLE 2
Freezing point depression of sodium lignin sulfonate(SL)

| m¹ (g) | ΔT (° C.) | Π (Bar) |
|---|---|---|
| 5 | 0.66 | 8.04 |
| 15 | 1.8 | 21.93 |
| 30 | 3.59 | 43.75 |
| 45 | 4.73 | 57.64 |
| 60 | 6.42 | 78.23 |

¹m grams of SL in 100 g H₂O

ΔT=0.10864×m(g SL in 100 g H₂O),R²=0.99708 (2)

Forward Osmosis Performance with Deionized Water as Feed
PA-based TFC membranes

For commercial PA-based reverse osmosis membranes, the forward osmosis performance is low based on previous studies. (See J. T. Arena, et al., which is incorporated by reference in its entirety). The hydrophobic thick polysulfone support with sponge structure and the PET fabric backing to withstand hydraulic pressure in the reverse osmosis process are considered the main causes of the severe ICP in the forward osmosis process, causing the decline in driving force and thus the low water flux.

FIG. 4 displays the forward osmosis performance of membrane RO₁ using NaCl and sodium lignin sulfonate as draw solutes. This experiment was done under the following conditions: the osmotic pressure of sodium lignin sulfonate was 78 bar; the osmotic pressure of NaCl was 84 bar; and active layer facing draw solution (AL-DS) and feed-DI. Both experienced a water flux decline, while water flux of using SL had a slower declining rate. For NaCl, it declined fast for the first 10 minutes and then reached a relatively stable stage, at around 4 LMH. For sodium lignin sulfonate, after 30 minutes, water flux still reached 30 LMH (12 LMH after 1 h). Many researchers reported the steady stage data and neglected the initial stage performance, while some researchers reported the initial stage water flux data. (See N. Y. Yip, et al.; J. R. McCutcheon et al.; and L. Shi, et al.; each of which is incorporated by reference in its entirety). Through the experiments related to the present invention, we have found that the initial stage is the period that salts penetrate and accumulate into the membrane, forming the concentration profile decreasing the driving force. Due to the relatively larger molecular size of sodium lignin sulfonate and the impurities within, it takes a longer time to reach the steady state, and the ICP is less severe after reaching steady state. The long duration of the ‘unsteady’ period with high water flux could be taken into use.

The method of the present invention involves cleaning the membrane with water. After a certain period of time, the sodium lignin sulfonate solution is to be switched to water on the draw solute side. The diffusion of water from the draw solute side to FD side facilitates the salt transport within the membrane so that it is removed. FIG. 5 shows the original data of weight change on the draw side and the salt concentration on the feed side of RO₁ membrane using sodium lignin sulfonate as a draw solute during the cleaning process. A, B and C in FIG. 5 are the cleaning points during which the feed water was kept running. For A, no water was used to wash the draw side, while for B and C, water on the draw side was used. High water flux was achieved after each cleaning point, and then the flux became level over time. A sharp increase of salt concentration in the feed water was observed after each cleaning, which shows the salt transport from the membrane to the feed water. Compared to the time for the salt concentration in the feed water to reach a steady concentration, the diffusion rates of B and C are faster than the rate of A. It was found in the present invention that 20 seconds can be a sufficient amount of time to wash the draw side with the feed side water running.

FIG. 6 shows forward osmosis performance of an NF270 membrane using sodium lignin sulfonate as the draw solute under a variety of osmotic pressures. At each test interval (from high osmotic pressure to low osmotic pressure), the draw side was washed with water for 20 seconds with the feed side water running. All tests experienced flux decline, and after reaching steady state, the flux did not vary much for different osmotic pressures. However, during the ‘unsteady’ state, all the fluxes are high. This provides a way of keeping a high flux during the entire process, with proper cleaning. This is also a reason why the primary focus of the experiments was on the initial performance of different membranes.

In the laboratory scale forward osmosis test, the osmotic pressure of the draw solute continued to decrease because of the dilution of the sodium lignin sulfonate. For sodium lignin sulfonate with the PA-based membranes, the dilution cannot be neglected due to the high water flux. To make it comparable, a 30 minute test time is set as one standard. FIG. 7 shows the forward osmosis performance of PA-based TFC membranes using sodium lignin sulfonate as the draw solute. The osmotic pressure of this test was set at 78 bar, and other conditions were AL-DS and feed-DI. Generally, all the membranes had a high initial water flux and experienced a decline. For NF membranes and brackish water reverse osmosis membranes, the initial water flux was around 60 LMH. NF270 even exceeded 80 LMH. For seawater reverse osmosis membranes, the initial water flux was around 40 LMH. For the overall performance, three groups can be divided into the following: brackish water reverse osmosis (RO₁, BE), NF membranes (NF270, HL) greater than seawater reverse osmosis (RO4, SHN) greater than NF membrane (DL). Generally all the membranes tested have very low salt fluxes (less than 0.3 GMH).

The steady state performance of multiple membranes was investigated. As shown in FIG. 8, water fluxes of RO₁, RO₁ without a PET fabric layer, NF270, DL and HL membranes are compared. The osmotic pressure of this test was set at 78 bar, and other conditions were AL-DS and feed-DI. The RO₁ membrane gave a good initial stage performance, while after 1 hour, the water flux dropped to 12 LMH. After removing the PET fabric layer, the water flux increased to around 20 LMH. For NF membranes, HL outperformed NF270 and DL with a steady state water flux around 22 LMH.

### Cellulose Acetate/Triacetate Based Membranes

In this section, four types of CA/CTA-based membranes are tested: (1) seawater reverse osmosis membrane CE, (2) NF membrane CK, (3) forward osmosis membrane CTA1 and (4) forward osmosis membrane CTA2.

As shown in FIG. 9, the CA/CTA-based membranes behaved differently from PA-based membranes. The osmotic pressure of this test was set at 78 bar, and other conditions were AL-DS and feed-DI. Their initial water fluxes are low and the flux decline is less compared with PA-based membranes (RO₁ and HL). For salt flux, all the membranes have very low salt fluxes (less than 0.3 gMH), except for CTA1 and CTA2.

CTA1 and CTA2 are the only two commercially available forward osmosis membranes. Detailed studies were conducted. FIGS. 10(a) and 10(b) compare the performance of using NaCl or sodium lignin sulfonate as draw solute under different osmotic pressures. FIG. 10(a) displays the results of test conditions using the CTA1 membrane. FIG. 10(b) displays the results of conditions using the CTA2 membrane. Test conditions included AL-DS and a feed solution of deionized water. Contrary to the PA-based membranes, water flux of using NaCl doubles the water flux of using sodium lignin sulfonate with CTA1 and CTA2. For salt flux, NaCl as a draw solute is about four times the flux of sodium lignin sulfonate with CTA1. For the denser CTA2 membrane, the salt fluxes are about the same range as the sodium lignin sulfonate flux.

A lignin-based draw solute candidate, sodium lignin sulfonate, was used to obtain water from wastewater or seawater in forward osmosis process. High osmotic pressure of the sodium lignin sulfonate solution can be obtained based on freezing point depression test. The performance was evaluated with several types of reverse osmosis, NF and forward osmosis membranes. For PA-based reverse osmosis, NF membranes, a long time unsteady state with high water flux was observed with DI water as feed. With proper and easy cleaning, this unsteady state can be maintained. Considering the low cost and natural abundance of sodium lignin sulfonate, combining membrane improvement and proper membrane cleaning, the combination of sodium lignin sulfonate and forward osmosis is able to make the desert green in a very efficient and economical way.

Other embodiments are within the scope of the following claims.

What is claimed is:

1. A process for extracting water from wastewater or seawater, comprising the steps of:
passing water from a feed solution comprising water and at least one solute dissolved therein with a first osmotic pressure, through a membrane into a second solution comprising a draw solute comprising an aryl sulfonate salt with a second osmotic pressure,
wherein the first osmotic pressure is lower than the second osmotic pressure.

2. The process of claim 1, wherein the aryl sulfonate salt is a lignin salt.

3. The process of claim 1, wherein the aryl sulfonate salt is an alkali or alkaline earth salt of a compound of formula (I): 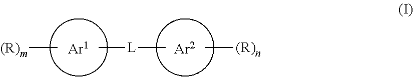
in which each of Ar¹ and Ar², independently, is an aryl group, such as phenyl, pyridyl, or naphthyl, each n and m, independently, is 0, 1, 2 or 3, L is a substituted or unsubstituted C₁-C₆ alkylene or alkenylene group optionally interrupted by O, S or NR^{a}, wherein the substituent is OH, OR^{a}, SH, SR^{a}, NH₂, NHR^{a}, NR^{a}₂, COOH, COOR², or SO₃OH, each R, independently, is OH, OR^{a}, SH, SR^{a}, NH₂, NHR^{a}, NR^{a}₂, COOH, COOR², or SO₃OH, and each R^{a} is substituted or unsubstituted C₁-C₆ alkyl or alkenyl group optionally interrupted by O, S or NR^{a}, wherein the substituent is OH, OR^{a}, SH, SR^{a}, NH₂, NHR^{a}, NR^{a}₂, COOH, COOR², or SO₃OH, in which at least two substituents are sulfonic acid or carboxylic acid.

4. The process of claim 1, wherein the aryl sulfonate salt is an alkali or alkaline earth salt of a compound of formula (II): 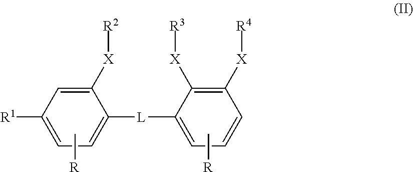
in which, L is a substituted or unsubstituted C₁-C₆ alkylene or alkenylene group optionally interrupted by O, S, NH or NR^{a}, wherein the substituent is OH, OR^{a}, SH, SR^{a}, NH₂, NHR^{a}, NR^{a}₂, COOH, COOR², or SO₃OH, each R, independently, is OH, OR^{a}, SH, SR^{a}, NH₂, NHR^{a}, NR^{a}₂, COOH, COOR², or SO₃OH, each X, independently, is O, S, NH or NR^{a}, each of R′, R², R³ and R⁴ is substituted or unsubstituted C₁-C₆ alkyl or alkenyl group optionally interrupted by O, S or NR^{a}, wherein the substituent is OH, OR^{a}, SH, SR^{a}, NH₂, NHR^{a}, NR^{a}₂, COOH, COOR², or SO₃OH, and each R^{a} is substituted or unsubstituted C₁-C₆ alkyl or alkenyl group optionally interrupted by O, S or NR^{a}, wherein the substituent is OH, OR^{a}, SH, SR^{a}, NH₂, NHR^{a}, NR^{a}₂, COOH, COOR², or SO₃OH, in which at least two substituents are sulfonic acid or carboxylic acid.

5. The process of claim 1, wherein the aryl sulfonate salt is an alkali or alkaline earth salt of a compound of formula (III): 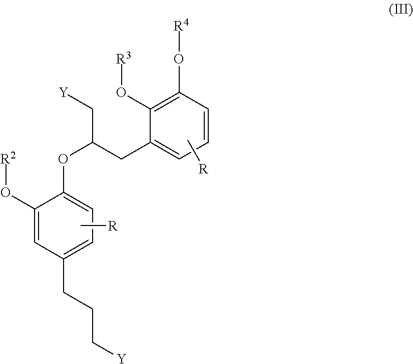
in which, each Y, independently, is OH, OR^{a}, SH, SR^{a}, NH₂, NHR^{a}, NR^{a}₂, COOH, COOR², or SO₃OH, each R, independently, is OH, OR^{a}, SH, SR^{a}, NH₂, NHR^{a}, NR^{a}₂, COOH, COOR², or SO₃OH, each of R², R³ and R⁴ is substituted or unsubstituted C₁-C₆ alkyl or alkenyl group optionally interrupted by O, S or NR^{a}, wherein the substituent is OH, OR^{a}, SH, SR^{a}, NH₂, NHR^{a}, NR^{a}₂, COOH, COOR², or SO₃OH, and each R^{a} is substituted or unsubstituted C₁-C₆ alkyl or alkenyl group optionally interrupted by O, S or NR^{a}, wherein the substituent is OH, OR^{a}, SH, SR^{a}, NH₂, NHR^{a}, NR^{a}₂, COOH, COOR², or SO₃OH, in which at least two substituents are sulfonic acid or carboxylic acid.

6. A process of claim 1 wherein the draw solute includes sodium lignin sulfonate.

7. A process of claim 1 further comprising the step of cleaning the membrane with water.

8. A process of claim 1 wherein the concentration of the second solution is between 40 and 80 grams of aryl sulfonate salt per 100 grams of water.

9. A process of claim 1 wherein the concentration of the second solution is between 60 and 70 grams of aryl sulfonate salt per 100 grams of water.

10. A forward osmosis fluid purification system comprising:
a cross-flow membrane module including a membrane;
a channel on each side of the membrane, which allows a feed solution and a draw solution to flow through separately;
a feed side configured to contain a solution consisting of unpurified water; and
a draw side including a draw solute, wherein the draw solute is an aryl sulfonate salt.

11. A system according to claim 10 wherein the draw solute includes sodium lignin sulfonate.
